(19) United States
(12) Patent Application Publication
(10) Pub. No.: US 2026/0111288 A1
(43) Pub. Date: Apr. 23, 2026

(54) DYNAMIC RESOURCE ALLOCATION FOR SYSTEM MANAGEMENT VM

(71) Applicant: Dell Products L.P., Round Rock, TX (US)

(72) Inventors: Weiyi XIE, Wuxi (CN); Yun SUN, Wuxi (CN); Lennon GENG, Shanghai (CN); Vivian Ziqin JIAN, Shanghai (CN)

(73) Assignee: Dell Products L.P., Round Rock, TX (US)

(21) Appl. No.: 18/933,181

(22) Filed: Oct. 31, 2024

(30) Foreign Application Priority Data
Oct. 21, 2024 (CN) 202411471102.1

(51) Int. Cl. G06F 9/50; G06F 13/40

(52) U.S. Cl. CPC G06F 9/5077; G06F 9/5016; G06F 13/4081

(57) ABSTRACT

An information handling system may include at least one processor and a memory. The information handling system may be configured to: receive a plurality of resource allocation profiles for a system management virtual machine (VM) of an information handling system cluster, wherein the resource allocation profiles are based on states and/or operations of the system management VM; and based on a change in state and/or operation, dynamically adjust resources of the system management VM in accordance with an associated one of the plurality of resource allocation profiles.

### TECHNICAL FIELD

The present disclosure relates in general to information handling systems, and more particularly to dynamic allocation of resources to a system management virtual machine.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Hyper-converged infrastructure (HCI) is an IT framework that combines storage, computing, and networking into a single system in an effort to reduce data center complexity and increase scalability. Hyper-converged platforms may include a hypervisor for virtualized computing, software-defined storage, and virtualized networking, and they typically run on standard, off-the-shelf servers. One type of HCI solution is the Dell EMC VxRail™ system. Some examples of HCI systems may operate in various environments (e.g., an HCI management system such as the VMware® vSphere® ESXi™ environment, or any other HCI management system). Some examples of HCI systems may operate as software-defined storage (SDS) cluster systems (e.g., an SDS cluster system such as the VMware® vSAN™ system, or any other SDS cluster system).

In the HCI context (as well as other contexts), information handling systems may execute virtual machines (VMs) for various purposes. A VM may generally comprise any program of executable instructions, or aggregation of programs of executable instructions, configured to execute a guest operating system on a hypervisor or host operating system in order to act through or in connection with the hypervisor/host operating system to manage and/or control the allocation and usage of hardware resources such as memory, central processing unit time, disk space, and input and output devices, and provide an interface between such hardware resources and application programs hosted by the guest operating system.

In some cases, a cluster may include one node designated as the primary node, which can act as the bootstrap node for setting up and provisioning the cluster, as well as carrying out various management tasks (e.g., system upgrades) once the cluster is operational. An HCI management system may execute within a VM on the primary node of the HCI cluster in some cases. This may be referred to herein as a system management VM or simply a management VM. (In other situations, the system management VM may execute on a node other than the primary node, on more than one node, etc.)

Some of the technologies that are incorporated in the management VM impose significant requirements in terms of processing and memory usage, especially during certain phases of cluster initialization and management VM reboots. Accordingly, significant CPU and memory resources may need to be allocated to the management VM during those phases. However, those resources may not be required during other phases (e.g., after the management VM has booted and after the cluster is already initialized).

In addition to processor and memory resources, the management VM may at times need a significant amount of storage. For example, during system upgrades, the management VM may need to download an update image file to its local storage and extract it, which could consume tens of gigabytes of storage or even more.

Accordingly, embodiments of this disclosure provide techniques for dynamically adjusting system resources (e.g., including CPU, memory, and/or storage resources) that are allocated to a management VM. These allocations may be adjusted based on the state and/or operations of the management VM. For example, more CPU and memory may be allocated to the management VM when it is first booting or when it is performing cluster initialization operations. As another example, additional disk storage may be allocated before and during system upgrade operations. When the demanding operations are complete, the extra resources may no longer be needed, and they may be released.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with resource allocation in system management VMs may be reduced or eliminated.

In accordance with embodiments of the present disclosure, an information handling system may include at least one processor and a memory. The information handling system may be configured to: receive a plurality of resource allocation profiles for a system management virtual machine (VM) of an information handling system cluster, wherein the resource allocation profiles are based on states and/or operations of the system management VM; and based on a change in state and/or operation, dynamically adjust resources of the system management VM in accordance with an associated one of the plurality of resource allocation profiles.

In accordance with these and other embodiments of the present disclosure, a method may include an information handling system receiving a plurality of resource allocation profiles for a system management virtual machine (VM) of an information handling system cluster, wherein the resource allocation profiles are based on states and/or operations of the system management VM; and based on a change in state and/or operation, the information handling system dynamically adjusting resources of the system management VM in accordance with an associated one of the plurality of resource allocation profiles.

In accordance with these and other embodiments of the present disclosure, an article of manufacture may include a non-transitory, computer-readable medium having computer-executable instructions thereon that are executable by an information handling system for: receiving a plurality of resource allocation profiles for a system management virtual machine (VM) of an information handling system cluster, wherein the resource allocation profiles are based on states and/or operations of the system management VM; and based on a change in state and/or operation, dynamically adjusting resources of the system management VM in accordance with an associated one of the plurality of resource allocation profiles.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure; and

FIG. 2 illustrates an example dynamic resource manager service, in accordance with embodiments of the present disclosure.

### DETAILED DESCRIPTION

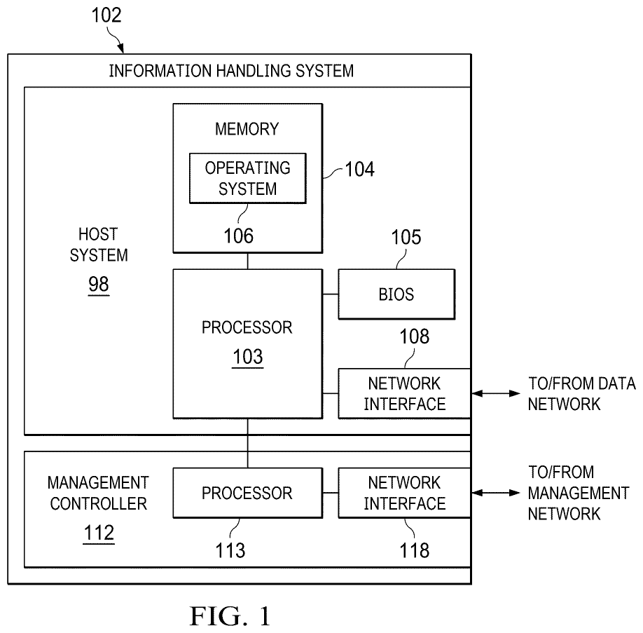

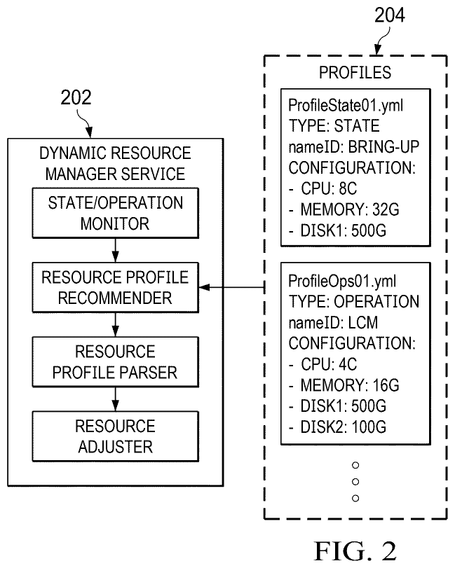

Preferred embodiments and their advantages are best understood by reference to FIGS. 1 and 2, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102. Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

As discussed above, embodiments of this disclosure may be used to dynamically adjust the resources that are available to a system management VM based on its state and/or operations. Information handling system 102 may be an HCI cluster or a primary node thereof, and so it may host a system management VM. It may also host a dynamic resource manager service 202, as depicted in FIG. 2. In other embodiments, a different node of an HCI cluster may host the dynamic resource manager service 202. In some embodiments, dynamic resource manager service 202 may run within a VM.

Dynamic resource manager service 202 may monitor the state and/or operations of the system management VM. It may also receive as an input one or more profiles 204. Profiles 204 may be specified in a markup language such as YAML as shown, or in any other suitable manner. FIG. 2 shows two example profiles, which specify the state or operation to which they are applicable, as well as the resources that should be allocated (e.g., CPU cores, memory, and disk space).

Profiles may be based on the state and/or the operations of the management VM. For example, a profile based on state may describe resource allocation for system states (e.g., cluster bring-up, daily operations, etc.). A profile based on operation may describe resource allocation for particular system operations (e.g., node addition, node replacement, etc.).

In some embodiments, dynamic resource manager service 202 may fetch the corresponding profile whenever the system state changes or when a specific operation starts. Dynamic resource manager service 202 may parse the profiles and compare their requirements to the existing resource allocation. If any differences are present, it may then adjust the resource allocation for the management VM accordingly.

In the case of a state profile, dynamic resource manager service 202 may keep the new allocation in force until the next state change. In the case of an operation profile, dynamic resource manager service 202 may revert the change once the operation in question has been completed.

For allocation of CPU and memory resources, embodiments may proceed in three phases, as follows.
1. In the development phase, various recommended CPU and memory requirements may be calculated for different system states and operations. These calculations may be based on real-world testing data by considering the CPU and memory resources that were consumed by similar systems during various states and operations.

Profiles 204 may then be generated for each state and operation. For example, a profile referred to as “RecommendedResource_Bringup” may be generated for system initialization (e.g., including tasks such as Kubernetes initialization, workflow engine initialization, etc.). Another profile referred to as “RecommendedResource_Boot” may be generated for the VM boot up phase (e.g., including tasks such as initialization of containers). Another profile referred to as “RecommendedResource_DayN” may be generated for the ordinary operation of the cluster.

In most cases, it may be expected that “RecommendedResource_Bringup”>“RecommendedResource_Boot”>“RecommendedResource_DayN” in terms of CPU and memory requirements.
2. In the cluster bring-up phase, the user may power on the nodes of the cluster, and the system management VM may start up to begin cluster bring-up. The “RecommendedResource_Bringup” profile may be loaded, and CPU and memory resources may be allocated accordingly. This profile may be the default configuration when a new system is shipped.

Once the cluster is initialized, the CPU and memory allocated to the system management VM may be dynamically reduced down to what is specified in the “RecommendedResource_DayN” profile.
3. During daily operations, the management VM may sometimes need to reboot, which may require more resources than specified by the “RecommendedResource_DayN” profile. Accordingly, before such a reboot, the system management VM may first retrieve information regarding the available CPU and memory resources of the whole cluster, referred to as “AvailableResource”. The system management VM may also retrieve information regarding its own current CPU and memory usage, referred to as “CurrentSysVMResource”.

The system management VM may then set its CPU and memory allocation to either “CurrentSysVMResource +AvailableResource” or “RecommendedResource_Boot”, whichever is smaller. The system management VM may then reboot itself. When it boots back up, the system management VM may dynamically restore its resource allocation to “RecommendedResource_DayN”.

These preceding phases are applicable to CPU and memory resource allocation, where the resource allocation may be changed via existing hot-plug functionality. Storage allocation is considered separately, because altering the storage size may incur a file system resize, which is a relatively expensive operation. In some implementations, it may be that allocating a new disk for upgrade storage is more efficient than altering the file system size of the management VM.

For allocation of storage resources, embodiments may proceed in two phases, as follows.
1. In the development phase, the amount of disk space needed for an upgrade operation is calculated. For example, the disk space requirement may include sufficient space for the image file to be downloaded, as well as the projected (or otherwise measured) size of the extracted upgrade files. This may be referred to as “UpgradeDiskSize”.
2. In the system upgrade phase, dynamic resource manager service 202 may allocate disk space for the system management VM in accordance with the “UpgradeDiskSize” requirement. The newly allocated storage may be mounted as a disk accessible by the system management VM.

The system upgrade may then be performed by downloading the upgrade image, extracting it, and installing the upgrade. After the upgrade is complete, the upgrade image and extracted files may be deleted, and the allocated disk may be unmounted to release the storage resources backing it.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system comprising:
at least one processor; and
a memory;
wherein the information handling system is configured to:
receive a plurality of resource allocation profiles for a system management virtual machine (VM) of an information handling system cluster, wherein the resource allocation profiles are based on states and/or operations of the system management VM; and
based on a change in state and/or operation, dynamically adjust resources of the system management VM in accordance with an associated one of the plurality of resource allocation profiles.

2. The information handling system of claim 1, wherein the resources of the system management VM comprise a number of processor cores and an amount of memory.

3. The information handling system of claim 2, wherein dynamically adjusting the resources comprises a hot-plug event.

4. The information handling system of claim 1, wherein the resources of the system management VM comprise an amount of disk space.

5. The information handling system of claim 4, wherein dynamically adjusting the resources comprises mounting or unmounting a disk accessible to the system management VM.

6. The information handling system of claim 1, wherein the information handling system cluster is a hyper-converged infrastructure (HCI) cluster.

7. A method comprising:
an information handling system receiving a plurality of resource allocation profiles for a system management virtual machine (VM) of an information handling system cluster, wherein the resource allocation profiles are based on states and/or operations of the system management VM; and
based on a change in state and/or operation, the information handling system dynamically adjusting resources of the system management VM in accordance with an associated one of the plurality of resource allocation profiles.

8. The method of claim 7, wherein the resources of the system management VM comprise a number of processor cores and an amount of memory.

9. The method of claim 8, wherein dynamically adjusting the resources comprises a hot-plug event.

10. The method of claim 7, wherein the resources of the system management VM comprise an amount of disk space.

11. The method of claim 10, wherein dynamically adjusting the resources comprises mounting or unmounting a disk accessible to the system management VM.

12. The method of claim 7, wherein the information handling system cluster is a hyper-converged infrastructure (HCI) cluster.

13. An article of manufacture comprising a non-transitory, computer-readable medium having computer-executable instructions thereon that are executable by an information handling system for:
receiving a plurality of resource allocation profiles for a system management virtual machine (VM) of an information handling system cluster, wherein the resource allocation profiles are based on states and/or operations of the system management VM; and
based on a change in state and/or operation, dynamically adjusting resources of the system management VM in accordance with an associated one of the plurality of resource allocation profiles.

14. The article of manufacture of claim 13, wherein the resources of the system management VM comprise a number of processor cores and an amount of memory.

15. The article of manufacture of claim 14, wherein dynamically adjusting the resources comprises a hot-plug event.

16. The article of manufacture of claim 13, wherein the resources of the system management VM comprise an amount of disk space.

17. The article of manufacture of claim 16, wherein dynamically adjusting the resources comprises mounting or unmounting a disk accessible to the system management VM.

18. The article of manufacture of claim 13, wherein the information handling system cluster is a hyper-converged infrastructure (HCI) cluster.
